(19) United States
(12) Patent Application Publication
(10) Pub. No.: US 2026/0117489 A1
(43) Pub. Date: Apr. 30, 2026

(54) WORK MACHINE, AND REMOTE OPERATION SYSTEM FOR WORK MACHINE

(71) Applicant: SUMITOMO HEAVY INDUSTRIES, LTD., Tokyo (JP)

(72) Inventors: Yusuke SANO, Kanagawa (JP); Ryota KAWAHARA, Kanagawa (JP)

(21) Appl. No.: 19/362,650

(22) Filed: Oct. 20, 2025

(30) Foreign Application Priority Data
Oct. 25, 2024 (JP) 2024-188533

(51) Int. Cl. E02F 9/12; E02F 3/32; E02F 9/20; G05D 1/222

(52) U.S. Cl. CPC E02F 9/123; E02F 3/32; E02F 9/205; G05D 1/222

(57) ABSTRACT

A work machine includes a lower traveling body; an upper slewing body slewably mounted on the lower traveling body; a slewing actuator configured to slew the upper slewing body relative to the lower traveling body; and a traveling actuator configured to cause the lower traveling body to travel. The work machine is configured to execute a traveling support function that executes automatic control of the traveling actuator and causes a direction of a front-rear axis of the lower traveling body and a direction of a front-rear axis of the upper slewing body to coincide with each other during traveling of the lower traveling body.

### CROSS-REFERENCE TO RELATED APPLICATIONS

This application is based upon and claims priority to Japanese Patent Application No. 2024-188533, filed on Oct. 25, 2024, the entire contents of which are incorporated herein by reference.

### BACKGROUND

### 1. Technical Field

The present disclosure relates to a work machine, and a remote operation system for the work machine.

### 2. Description of Related Art

A traveling direction display device for a construction machine is known. This device is configured to detect a slewing position of an upper slewing body relative to a lower traveling body, thereby enabling an operator in a cab of the construction machine to recognize a traveling direction of the lower traveling body (i.e., a direction of the front-rear axis of the lower traveling body).

### SUMMARY

A work machine according to an embodiment of the present disclosure includes: a lower traveling body; an upper slewing body slewably mounted on the lower traveling body; a slewing actuator configured to slew the upper slewing body relative to the lower traveling body; and a traveling actuator configured to cause the lower traveling body to travel. The work machine is configured to execute a traveling support function that executes automatic control of the traveling actuator and causes a direction of a front-rear axis of the lower traveling body and a direction of a front-rear axis of the upper slewing body to coincide with each other during traveling of the lower traveling body.

### BRIEF DESCRIPTION OF THE DRAWINGS

FIG. 1 is a schematic diagram illustrating an example of a remote operation system for a work machine according to an embodiment of the present disclosure;

FIG. 2 is a side diagram of a work machine according to an embodiment of the present disclosure;

FIG. 3 is a diagram illustrating a configuration example of a hydraulic system for the work machine illustrated in FIG. 2;

FIG. 4A, FIG. 4B, and FIG. 4C are diagrams illustrating a configuration example of a part of the hydraulic system of the work machine illustrated in FIG. 2;

FIG. 5 is a block diagram illustrating a configuration example of a traveling support system;

FIG. 6 is a flowchart illustrating an example of a flow of a traveling support process;

FIG. 7 is a top diagram of the work machine illustrating an example of movement of the work machine when traveling operations are performed;

FIG. 8 is a top diagram of the work machine illustrating another example of the movement of the work machine when the traveling operations are performed;

FIG. 9 is a top diagram of the work machine illustrating yet another example of the movement of the work machine when the traveling operations are performed; and

FIG. 10 is a top diagram of the work machine illustrating yet another example of the movement of the work machine when the traveling operations are performed.

### DETAILED DESCRIPTION

When the direction of the front-rear axis of the upper slewing body does not coincide with the direction of the front-rear axis of the lower traveling body, the operator needs to perform complicated operations, such as an operation for curving, in order to cause the lower traveling body to travel along the direction of the front-rear axis of the upper slewing body.

Therefore, it is desirable to provide a work machine configured to cause the lower traveling body to travel along the direction of the front-rear axis of the upper slewing body by a simple operation.

Hereinafter, embodiments of the present disclosure will be described with reference to the drawings. The embodiments as described below do not limit the present disclosure but are illustrative. All of the features described in the embodiments and combinations of the features are not necessarily essential to the present disclosure. Throughout the drawings, the same or corresponding components are denoted by the same or corresponding symbols, and description may be omitted.

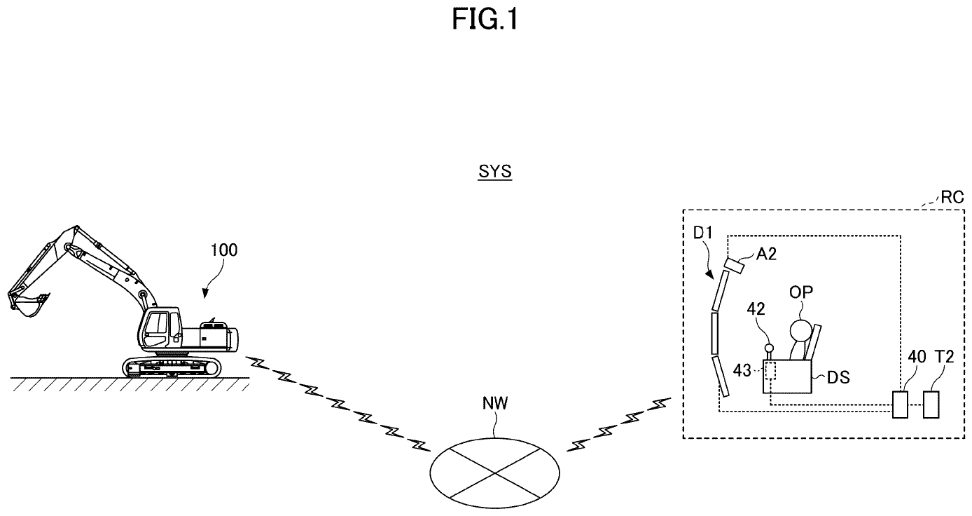

First, an overview of a remote operation system SYS for a work machine according to an embodiment of the present disclosure will be described with reference to FIG. 1. FIG. 1 is a schematic diagram illustrating an example of the remote operation system SYS.

As illustrated in FIG. 1, the remote operation system SYS includes a work machine 100 and a remote operation room RC. The work machine 100 and the remote operation room RC are connected to each other to enable data transmission and reception via a communication line NW. In the illustrated example, the work machine 100 is configured to enable data transmission to and data reception from the remote operation room RC via the communication line NW.

Specifically, for example, the work machine 100 can transmit information of a work site to the remote operation room RC. A remote operator OP, who is an operator located in the remote operation room RC, can confirm a situation of the work site in accordance with the information from the work machine 100. A device configured to perform measurement of the work site is not only a device attached to the work machine 100, but also may be, for example: a drone configured to fly above the work site; a fixed-point camera installed in the work site; or a photographing device configured to be carried by a worker located in the work site.

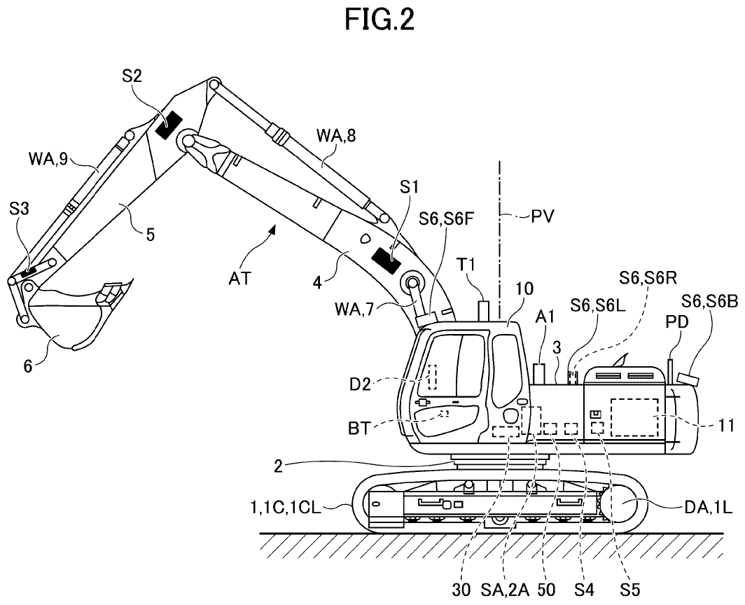

For example, the work machine 100 includes a space recognition device S6 (see FIG. 2). The work machine 100 can transmit, to the remote operation room RC, an image of the work site photographed by the space recognition device S6.

The number of the work machines 100 included in the remote operation system SYS may be one or more. Thus, the remote operation system SYS can acquire information of the work site from the two or more work machines 100, and transmit the acquired information to the remote operation room RC.

The remote operation room RC includes a remote controller 40, an operation device 42, an operation sensor 43, a speaker A2, a display device D1, a communication device T2, and the like. Also, the remote operation room RC includes an operating seat DS for the remote operator OP, who remotely operates the work machine 100.

The communication device T2 is configured to control communication with a communication device T1 attached to the work machine 100.

The remote controller 40 is a control device configured to execute various calculations. In the illustrated example, the remote controller 40 is configured by a microcomputer including a CPU, a memory, a nonvolatile storage device, and the like. Various functions of the remote controller 40 are realized by the CPU executing programs stored in the memory.

The display device D1 displays a screen based on information transmitted from the work machine 100 such that the remote operator OP in the remote operation room RC can visually recognize the surroundings of the work machine 100. The remote operator OP can confirm a situation of the work site including the surroundings of the work machine 100 by viewing the screen displayed on the display device D1. In the illustrated example, although the display device D1 is a liquid crystal display, the display device D1 may be XR (augmented reality) goggles or the like.

The operation device 42 is a device used by the remote operator OP to operate an actuator mounted on the work machine 100. The actuator includes at least one of a hydraulic actuator or an electric actuator. In terms of functions, the actuator includes a slewing actuator SA, a traveling actuator DA, a working actuator WA, and the like, as illustrated in FIG. 2.

In the illustrated example, the operation device 42 includes an operation lever, a traveling lever, and a traveling pedal. The operation lever includes a left operation lever for slewing operation and arm operation, and a right operation lever for boom operation and bucket operation. In the following, when the left operation lever is used for slewing operation, the left operation lever is referred to as a slewing operation device 26S or a slewing operation lever, and when the left operation lever is used for arm operation, the left operation lever is referred to as an arm operation device or an arm operation lever. Also, when the right operation lever is used for boom operation, the right operation lever is referred to as a boom operation device or a boom operation lever, and when the right operation lever is used for bucket operation, the right operation lever is referred to as a bucket operation device or a bucket operation lever. Each of the traveling lever and the traveling pedal is also referred to as a traveling operation device 26D.

The operation device 42 includes an operation sensor 43 configured to detect operation content of the operation device 42. The operation sensor 43 is, for example, a tilt sensor configured to detect a tilt angle of the operation lever, or an angle sensor configured to detect a pivot angle about a pivot shaft of the operation lever. The operation sensor 43 may include another sensor, such as a pressure sensor, a current sensor, a voltage sensor, a distance sensor, or the like. The operation sensor 43 outputs, to the remote controller 40, information of the detected operation content of the operation device 42. The remote controller 40 generates an operation signal based on the received information, and transmits the generated operation signal to the work machine 100. The operation sensor 43 may be configured to generate an operation signal. In this case, the operation sensor 43 may output the operation signal to the communication device T2 without the remote controller 40. Thus, the remote operator OP can remotely operate the work machine 100 from the remote operation room RC.

The speaker A2 outputs sound information received from the work machine 100 for causing the remote operator OP in the remote operation room RC to recognize sounds generated around the work machine 100.

Next, the work machine 100 will be described in detail with reference to FIG. 2. FIG. 2 is a side diagram of an excavator (shovel) that is an example of the work machine 100. The work machine 100 may be a crane. In the illustrated example, an upper slewing body 3 is slewably mounted on a lower traveling body 1 of the work machine 100 via a slewing mechanism 2. A boom 4 is attached to the upper slewing body 3, an arm 5 is attached to the tip of the boom 4, and a bucket 6 serving as an end attachment is attached to the tip of the arm 5. The end attachment may be a breaker, a grapple, or the like.

In the illustrated example, the lower traveling body 1 is a crawler-type traveling body including a crawler 1C, and includes a left crawler 1CL and a right crawler 1CR. The crawler 1C is driven by the traveling actuator DA. However, the lower traveling body 1 may be a wheel-type traveling body including four wheels. In this case, the four wheels may be independently steered and independently driven to rotate.

The boom 4, the arm 5, and the bucket 6 form an excavating attachment, which is an example of an attachment AT. The boom 4, the arm 5, and the bucket 6 are driven by a boom cylinder 7, an arm cylinder 8, and a bucket cylinder 9, which are each a hydraulic cylinder that is an example of the working actuator WA. A boom angle sensor S1 is attached to the boom 4, an arm angle sensor S2 is attached to the arm 5, and a bucket angle sensor S3 is attached to the bucket 6.

The boom angle sensor S1 is configured to detect a rotation angle of the boom 4. In the present embodiment, the boom angle sensor S1 is an acceleration sensor, and can detect a boom angle that is the rotation angle of the boom 4 with respect to the upper slewing body 3. The boom angle is, for example, the minimum angle when the boom 4 is moved down to the lowest position, and the boom angle increases as the boom 4 is raised.

The arm angle sensor S2 is configured to detect a rotation angle of the arm 5. In the present embodiment, the arm angle sensor S2 is an acceleration sensor, and can detect an arm angle that is the rotation angle of the arm 5 with respect to the boom 4. The arm angle is, for example, the minimum angle when the arm 5 is closed at most, and the arm angle increases as the arm 5 is opened.

The bucket angle sensor S3 is configured to detect a rotation angle of the bucket 6. In the present embodiment, the bucket angle sensor S3 is an acceleration sensor, and can detect a bucket angle that is the rotation angle of the bucket 6 with respect to the arm 5. The bucket angle is, for example, the minimum angle when the bucket 6 is closed at most, and the bucket angle increases as the bucket 6 is opened.

The boom angle sensor S1, the arm angle sensor S2, and the bucket angle sensor S3 may each be, for example, a potentiometer using a variable resistor, a stroke sensor that detects a stroke amount of a corresponding hydraulic cylinder, or a rotary encoder that detects the rotation angle about a coupling pin. The boom angle sensor S1, the arm angle sensor S2, and the bucket angle sensor S3 form a posture sensor AS configured to detect a posture of the excavating attachment.

The upper slewing body 3 includes the cab 10 serving as an operating compartment, an engine 11, an orientation detector 50, a microphone array A1, a positioning device PD, a machine body tilt sensor S4, a slewing angle velocity sensor S5, a space recognition device S6, a slewing actuator SA, the communication device T1, and the like.

The cab 10 includes a controller 30. Also, the cab 10 includes a driver's seat, an operation device 26, a traveling support button BT, a display device D2, and the like. The controller 30 is a control device configured to execute various calculations. The controller 30 is provided, for example, in the cab 10, and is configured to perform drive control of the work machine 100. The functions of the controller 30 may be realized by hardware, software, or a combination of hardware and software. For example, the controller 30 is formed mainly by a microcomputer including: a central processing unit (CPU); a memory (volatile storage device), such as a random access memory (RAM) or the like; a nonvolatile storage device, such as a read only memory (ROM) or the like; and an interface device for various inputs and outputs. The controller 30 may realize various functions, for example, by executing, on the CPU, various programs installed in the nonvolatile storage device.

The engine 11 is an example of a drive source of the work machine 100. In the illustrated example, the engine 11 is a diesel engine, and is mounted at the rear of the upper slewing body 3. An output shaft of the engine 11 is connected to input shafts of a main pump 14 and a pilot pump 15.

Specifically, the engine 11 rotates at a predetermined target rotation speed under direct or indirect control by the controller 30, thereby driving the main pump 14, the pilot pump 15, and the like. The drive source of the work machine 100 may be a battery-driven electric motor. That is, the work machine 100 may be a hybrid work machine or may be an electric work machine.

The machine body tilt sensor S4 is configured to detect a tilt of the upper slewing body 3 relative to a predetermined plane. In the illustrated example, the machine body tilt sensor S4 is an acceleration sensor configured to detect tilt angles of the upper slewing body 3 relative to a horizontal plane about a front-rear axis and a right-left axis. The front-rear axis and the right-left axis of the upper slewing body 3 are, for example, orthogonal to each other to pass through a center point that is a point on a slewing axis PV of the work machine 100.

The slewing angle velocity sensor S5 is configured to detect a slewing angle velocity of the upper slewing body 3. In the present embodiment, the slewing angle velocity sensor S5 is a gyro sensor. The slewing angle velocity sensor S5 may be a resolver, a rotary encoder, or the like. Also, the slewing angle velocity sensor S5 may be configured to detect a slewing velocity. Also, the slewing velocity may be calculated from the slewing angle velocity.

The space recognition device S6 is configured to acquire an image of the surroundings of the work machine 100. In the illustrated example, the space recognition device S6 includes a front camera S6F configured to photograph a space in front of the work machine 100, a left camera S6L configured to photograph a space leftward of the work machine 100, a right camera S6R configured to photograph a space rightward of the work machine 100, and a rear camera S6B configured to photograph a space rearward of the work machine 100.

The space recognition device S6 is, for example, a monocular camera having a photographing element, such as a CCD, a CMOS, or the like, and may output a photographed image to the display device D2.

The front camera S6F is attached, for example, to the roof of the cab 10. The left camera S6L is attached to a left end of the upper surface of the upper slewing body 3. The right camera S6R is attached to a right end of the upper surface of the upper slewing body 3. The rear camera S6B is attached to a rear end of the upper surface of the upper slewing body 3.

The space recognition device S6 provided at the above-described position can photograph an object existing around the work machine 100. The space recognition device S6 may be a camera (e.g., an RGBD camera or a stereo camera) configured to recognize a distance up to an object to be photographed. The space recognition device S6 may be a LiDAR sensor.

The positioning device PD is configured to acquire information of the position of the work machine 100. In the present embodiment, the positioning device PD is configured to measure the position and the orientation of the work machine 100. Specifically, the positioning device PD is a global navigation satellite system (GNSS) receiver including an electronic compass, and is configured to measure the latitude, the longitude, and the altitude of the current position of the work machine 100, and measure the orientation of the work machine 100 (the upper slewing body 3). In the illustrated example, a reference coordinate system is the world geodetic system. The world geodetic system is a three-dimensional orthogonal XYZ coordinate system in which the origin is set at the center of gravity of the globe, an X axis is taken in a direction toward the intersection between the Greenwich meridian and the equator, a Y axis is taken in a direction at 90 degrees of the east longitude, and a Z axis is taken in a direction toward the North Pole.

The orientation detector 50 is configured to detect information of a relative relationship between the orientation of the upper slewing body 3 and the orientation of the lower traveling body 1. For example, the orientation detector 50 may include a combination of: a geomagnetic sensor attached to the lower traveling body 1; and a geomagnetic sensor attached to the upper slewing body 3. Alternatively, the orientation detector 50 may include a combination of: a lower positioning device (a GNSS receiver including an electronic compass) attached to the lower traveling body 1; and a positioning device PD (a GNSS receiver including an electronic compass) attached to the upper slewing body 3. Alternatively, the orientation detector 50 may include a combination of: a geomagnetic sensor or positioning device PD (a GNSS receiver including an electronic compass) attached to the upper slewing body 3; and a rotary encoder or a rotary position sensor. Alternatively, in a configuration in which the upper slewing body 3 is driven to slew by a slewing electric generator, which is an example of the slewing actuator, the orientation detector 50 may include a combination of: a geomagnetic sensor or the positioning device PD (a GNSS receiver including an electronic compass) attached to the upper slewing body 3; and a resolver.

Alternatively, the orientation detector 50 may include a camera attached to the upper slewing body 3. In this case, the orientation detector 50 detects an image of the lower traveling body 1 by applying known image recognition processing to an image (input image) photographed by the camera attached to the upper slewing body 3, thereby determining a longitudinal direction that is a direction along the front-rear axis of the lower traveling body 1. The front-rear axis and left-right axis of the lower traveling body 1 are, for example, orthogonal to each other and pass through a center point, which is a point on the slewing axis PV of the work machine 100. Then, the orientation detector 50 derives an angle formed between the front-rear axis of the upper slewing body 3 and the front-rear axis of the lower traveling body 1. The direction of the front-rear axis of the upper slewing body 3 is derived from the position at which the camera is attached. In particular, when the lower traveling body 1 is a crawler-type traveling body, since the crawler 1C projects from the upper slewing body 3, the orientation detector 50 can detect an image of the crawler 1C to determine the longitudinal direction of the lower traveling body 1. In this case, the orientation detector 50 may be integrated with the controller 30. Also, the camera may be the space recognition device S6.

Alternatively, the orientation detector 50 may include a combination of: the positioning device PD (a GNSS receiver including an electronic compass) attached to the upper slewing body 3; and a slewing angle velocity sensor S5 configured to detect a slewing angle.

The communication device T1 is configured to control communication with a device outside the work machine 100. In the present embodiment, the communication device T1 is configured to control communication between the communication device T1 and the device outside the work machine 100 via a wireless communication network. The communication device T1 may include, for example, a mobile communication module responding to a mobile communication standard (e.g., LTE (Long Term Evolution), 4G (4th Generation), or 5G (5th Generation)), or a satellite communication module for connecting to the satellite communication network.

Also, the communication device T1 may be configured, for example, to control wireless communication between an external GNSS survey system and the work machine 100.

The microphone array A1 includes a plurality of microphones, and is configured to collect sounds generated around the work machine 100. In the illustrated example, the microphone array A1 is a plurality of microphones attached to the upper slewing body 3.

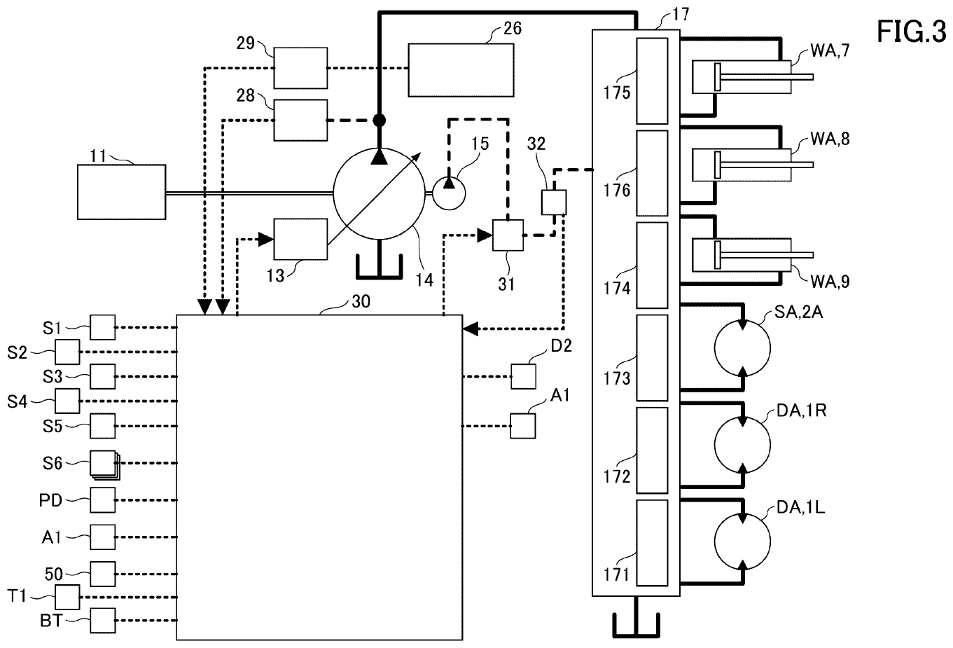

FIG. 3 is a diagram illustrating a configuration example of a drive control system for the work machine 100 illustrated in FIG. 2. In FIG. 3, a mechanical power transmission system is indicated by a double line, a hydraulic oil line is indicated by a thick solid line, a pilot line is indicated by a broken line, and an electric drive/control system is indicated by a dotted line.

A drive system of the work machine 100 according to the present embodiment includes the engine 11, a regulator 13, the main pump 14, and the control valve unit 17. A hydraulic drive system of the work machine 100 includes traveling hydraulic motors (a left traveling hydraulic motor 1L and a right traveling hydraulic motor 1R) serving as the traveling actuator DA, a slewing hydraulic motor 2A serving as a slewing actuator SA, and the boom cylinder 7, the arm cylinder 8, and the bucket cylinder 9 each serving as the working actuator WA.

The regulator 13 is configured to control the discharge amount of the main pump 14. In the illustrated example, the regulator 13 adjusts the angle (tilt angle) of a swashplate of the main pump 14 in accordance with a control command from the controller 30.

Similar to the engine 11, the main pump 14 is mounted in the upper slewing body 3, and supplies hydraulic oil to the control valve unit 17 through the hydraulic oil line. The main pump 14 is driven by the engine 11. In the illustrated example, the main pump 14 is a variable displacement hydraulic pump. When the tilt angle of the swashplate is adjusted by the regulator 13 under control by the controller 30, the stroke length of a piston is adjusted and the discharge flow rate (discharge pressure) is controlled.

The control valve unit 17 is a hydraulic control device configured to control a hydraulic system in the work machine 100. In the illustrated example, the control valve unit 17 includes control valves 171 to 176 as spool valves. The control valve unit 17 is configured to selectively supply hydraulic oil discharged by the main pump 14 to one or more hydraulic actuators through the control valves 171 to 176. The control valves 171 to 176 control, for example, the flow rate of hydraulic oil flowing from the main pump 14 to the hydraulic actuators and the flow rate of hydraulic oil flowing from the hydraulic actuators to a hydraulic oil tank. The hydraulic actuators include the boom cylinder 7, the arm cylinder 8, the bucket cylinder 9, the left traveling hydraulic motor 1L, the right traveling hydraulic motor 1R, and the slewing hydraulic motor 2A. Specifically, the control valve 171 corresponds to the left traveling hydraulic motor 1L, the control valve 172 corresponds to the right traveling hydraulic motor 1R, and the control valve 173 corresponds to the slewing hydraulic motor 2A. Also, the control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device, and is configured to supply hydraulic oil to a hydraulic control device through a pilot line. In the present embodiment, the pilot pump 15 is a fixed displacement hydraulic pump. However, the pilot pressure generating device may be realized by the main pump 14. That is, the main pump 14 may have a function of supplying hydraulic oil to various hydraulic control devices through a pilot line, in addition to the function of supplying hydraulic oil to the control valve unit 17 through the hydraulic oil line. In this case, provision of the pilot pump 15 may be omitted.

The operation device 26 is a device used by the operator in the cab 10 to operate an actuator. The actuator includes at least one of a hydraulic actuator or an electric actuator. In the illustrated example, similar to the operation device 42, the operation device 26 includes an operation lever, a traveling lever, and a traveling pedal. The operation lever includes a left operation lever for a slewing operation and an arm operation, and a right operation lever for a boom operation and a bucket operation.

A discharge pressure sensor 28 is configured to detect the discharge pressure of the main pump 14. In the present embodiment, the discharge pressure sensor 28 outputs the detected value to the controller 30.

An operation sensor 29 is configured to detect operation content of the operator using the operation device 26. In the present embodiment, the operation sensor 29 detects an operation direction and an operation amount of the operation device 26 corresponding to each of the actuators, and outputs the detected values to the controller 30. In the illustrated example, the controller 30 controls an opening area of an electromagnetic valve 31 in accordance with the output of the operation sensor 29. The controller 30 applies a pressure of hydraulic oil discharged by the pilot pump 15 to pilot ports of corresponding control valves in the control valve unit 17. The pressure (pilot pressure) of hydraulic oil applied to each of the pilot ports is, in principle, a pressure in accordance with the direction and the amount of the operation of the operation device 26 corresponding to each of the hydraulic actuators. In this manner, the operation device 26 is configured to apply the pressure of hydraulic oil discharged by the pilot pump 15 to the pilot ports of the corresponding control valves in the control valve unit 17.

The electromagnetic valve 31, which functions as a control valve for machine control, is disposed in an oil path connecting the pilot pump 15 and the pilot port of the control valve in the control valve unit 17, and is configured to change the flow path area of the oil path. In the illustrated example, the electromagnetic valve 31 operates in accordance with a control command output by the controller 30. Therefore, the controller 30 can apply the pressure of hydraulic oil discharged by the pilot pump 15 to the pilot port of the control valve in the control valve unit 17 through the electromagnetic valve 31 independently of the operation of the operation device 26 by the operator, thereby realizing a desired pilot pressure. In the illustrated example, the controller 30 is configured to feedback-control the pilot pressure based on an output of a pilot pressure sensor 32.

With this configuration, not only when the specific operation device 26 is operated but also when the specific operation device 26 is not operated, the controller 30 can operate the hydraulic actuator corresponding to that specific operation device 26.

Also, the controller 30 is configured to perform various functions other than the function of controlling the pilot pressure. For example, the controller 30 can set a target rotation speed based on a working mode or the like that is previously set by a predetermined operation of the operator or the like, thereby performing drive control to rotate the engine 11 at a constant speed.

Also, the controller 30 can output a control command to the regulator 13, if necessary, to change the discharge amount of the main pump 14.

Also, the controller 30 can perform, for example, control of a machine guidance function for guiding the operator manually operating the work machine 100 through the operation device 26. Also, the controller 30 can perform, for example, control of a machine control function for automatically supporting the operator manually operating the attachment AT through the operation device 26.

Some of the functions of the controller 30 may be realized by another controller (control device). That is, the functions of the controller 30 may be realized by a plurality of controllers. For example, the machine guidance function and the machine control function may be realized by respective dedicated controllers (control devices).

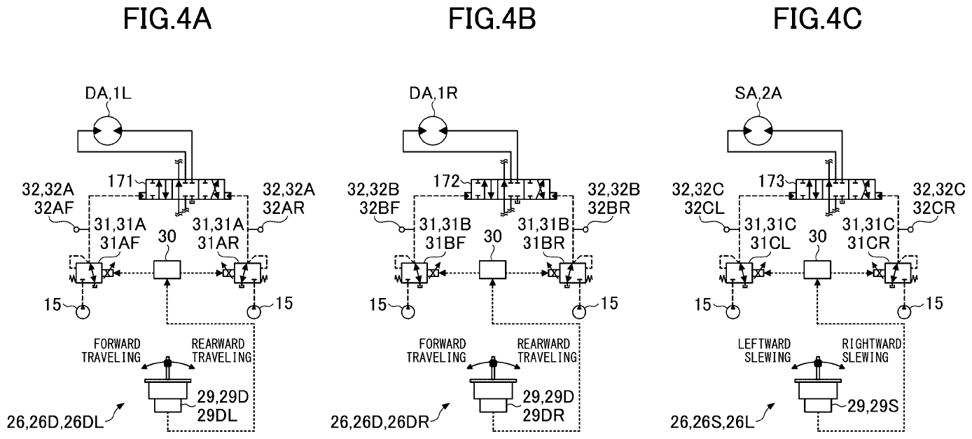

Next, a configuration in which the traveling support function executed by the controller 30 drives the traveling actuator DA and the slewing actuator SA will be described with reference to FIGS. 4A to 4C. FIGS. 4A to 4C are partial diagrams of the hydraulic system. Specifically, FIG. 4A is a partial diagram for an operation of the left traveling hydraulic motor 1L, FIG. 4B is a partial diagram for an operation of the right traveling hydraulic motor 1R, and FIG. 4C is a partial diagram for an operation of the slewing hydraulic motor 2A.

As illustrated in FIGS. 4A to 4C, the hydraulic system includes the electromagnetic valve 31. The electromagnetic valve 31 includes a left traveling electromagnetic valve 31A configured to drive the left traveling hydraulic motor 1L, a right traveling electromagnetic valve 31B configured to drive the right traveling hydraulic motor 1R, and a slewing electromagnetic valve 31C configured to drive the slewing hydraulic motor 2A. Specifically, the left traveling electromagnetic valve 31A includes a left forward traveling electromagnetic valve 31AF and a left rearward traveling electromagnetic valve 31AR, the right traveling electromagnetic valve 31B includes a right forward traveling electromagnetic valve 31BF and a right rearward traveling electromagnetic valve 31BR, and the slewing electromagnetic valve 31C includes a left slewing electromagnetic valve 31CL and a right slewing electromagnetic valve 31CR.

In the illustrated example, a left traveling lever 26DL and a right traveling lever 26DR, which are each the traveling operation device 26D, are used for the traveling operation, and a left operation lever 26L, which is the slewing operation device 26S, is used for the slewing operation. Also, the operation sensor 29 includes a traveling operation sensor 29D configured to detect an amount of operation and a direction of operation of the traveling operation device 26D, and a slewing operation sensor 29S configured to detect an amount of operation and a direction of operation of the slewing operation device 26S. The traveling operation sensor 29D includes a left traveling operation sensor 29DL configured to detect an amount of operation and a direction of operation of the left traveling lever 26DL, and a right traveling operation sensor 29DR configured to detect an amount of operation and a direction of operation of the right traveling lever 26DR.

Specifically, the left traveling lever 26DL uses hydraulic oil discharged by the pilot pump 15 to apply a pilot pressure, in accordance with an operation in the front-rear direction, to a pilot port of the control valve 171. More specifically, when the left traveling lever 26DL is operated in a forward traveling direction (forward direction), the controller 30 applies a pilot pressure, in accordance with an amount of the operation, to a left pilot port of the control valve 171. Also, when the left traveling lever 26DL is operated in a rearward traveling direction (rearward direction), the controller 30 applies a pilot pressure, in accordance with an amount of the operation, to a right pilot port of the control valve 171.

The right traveling lever 26DR uses hydraulic oil discharged by the pilot pump 15 to apply a pilot pressure, in accordance with an operation in the front-rear direction, to a pilot port of the control valve 172. Specifically, when the right traveling lever 26DR is operated in the forward traveling direction (forward direction), the controller 30 applies a pilot pressure, in accordance with an amount of the operation, to a left pilot port of the control valve 172. Also, when the right traveling lever (not shown) is operated in the rearward traveling direction (rearward direction), the controller 30 applies a pilot pressure, in accordance with an amount of the operation, to a right pilot port of the control valve 172.

Similarly, the left operation lever 26L uses hydraulic oil discharged by the pilot pump 15 to apply a pilot pressure, in accordance with an operation in the left-right direction, to a pilot port of the control valve 173. Specifically, when the left operation lever 26L is operated in the leftward slewing direction (leftward direction), the controller 30 applies a pilot pressure, in accordance with an amount of the operation, to a left pilot port of the control valve 173. When the left operation lever 26L is operated in the rightward slewing direction (rightward direction), the controller 30 applies a pilot pressure, in accordance with an amount of the operation, to a right pilot port of the control valve 173.

The electromagnetic valve 31 operates in response to a control command (current command) output by the controller 30, and can adjust the pilot pressure such that the corresponding control valve can stop at a desired valve position. Specifically, the pilot pressure on the left side of the control valve 171 is adjusted by hydraulic oil from the pilot pump 15 to the left pilot port of the control valve 171 via the left forward traveling electromagnetic valve 31AF, and the pilot pressure on the right side of the control valve 171 is adjusted by hydraulic oil from the pilot pump 15 to the right pilot port of the control valve 171 via the left rearward traveling electromagnetic valve 31AR. The same applies to the control valve 172 and the control valve 173.

Also, a pilot line connecting the left forward traveling electromagnetic valve 31AF and the left port of the control valve 171 is provided with a left traveling pilot pressure sensor 32A (left forward traveling pilot pressure sensor 32AF), and a pilot line connecting the left forward traveling electromagnetic valve 31AF and the right port of the control valve 171 is provided with the left traveling pilot pressure sensor 32A (left rearward traveling pilot pressure sensor 32AR). Also, a pilot line connecting the right forward traveling electromagnetic valve 31BF and the left port of the control valve 172 is provided with a right traveling pilot pressure sensor 32B (right forward traveling pilot pressure sensor 32BF), and a pilot line connecting the right forward traveling electromagnetic valve 31BF and the right port of the control valve 172 is provided with the right traveling pilot pressure sensor 32B (right rearward traveling pilot pressure sensor 32BR). Similarly, a pilot line connecting the left slewing electromagnetic valve 31CL and the left port of the control valve 173 is provided with a slewing pilot pressure sensor 32C (left slewing pilot pressure sensor 32CL), and a pilot line connecting the right slewing electromagnetic valve 31CR and the right port of the control valve 173 is provided with the slewing pilot pressure sensor 32C (right slewing pilot pressure sensor 32CR). The values detected by the pilot pressure sensors 32 are transmitted to the controller 30.

With this configuration, for example, in response to a forward traveling operation of the left traveling lever 26DL performed by the operator, the controller 30 can cause the pressure of hydraulic oil discharged by the pilot pump 15 to be applied to the left pilot port of the control valve 171 via the left forward traveling electromagnetic valve 31AF. Also, independently of the forward traveling operation of the left traveling lever 26DL performed by the operator, the controller 30 can cause the pressure of hydraulic oil discharged by the pilot pump 15 to be applied to the left pilot port of the control valve 171 via the left forward traveling electromagnetic valve 31AF. That is, the controller 30 can cause the left crawler 1CL to travel forward in response to the forward traveling operation of the left traveling lever 26DL performed by the operator or independently of the forward traveling operation of the left traveling lever 26DL performed by the operator. The same applies to rearward traveling of the left crawler 1CL, forward traveling of the right crawler 1CR, rearward traveling of the right crawler 1CR, leftward slewing of the upper slewing body 3, and rightward slewing of the upper slewing body 3.

The above description with reference to FIGS. 4A to 4C relates to a configuration in which the traveling support function executed by the controller 30 drives at least one of the left traveling hydraulic motor 1L, the right traveling hydraulic motor 1R, or the slewing hydraulic motor 2A. The same applies to a configuration in which the machine control function executed by the controller 30 drives the boom cylinder 7, the arm cylinder 8, the bucket cylinder 9, and the like.

Although an electric operation lever has been described as the operation device 26, a hydraulic operation lever may be employed instead of the electric operation lever. In this case, for example, the controller 30 can cause the pilot pressure generated by the hydraulic operation lever to be applied, via a proportional valve and a pressure reducing valve, to a pilot port of the control valve of a control valve unit configured to drive an actuator. Also, when it is desired to stop the drive target, the controller 30 can reduce the amount of hydraulic oil flowing into the pilot port by opening the pressure reducing valve. Thus, for example, the controller 30 can stop the operation device 26 corresponding to the drive target, and thus stop the drive target. In this manner, even if the hydraulic operation lever is employed, the controller 30 can realize the same control as the control using the electric operation lever.

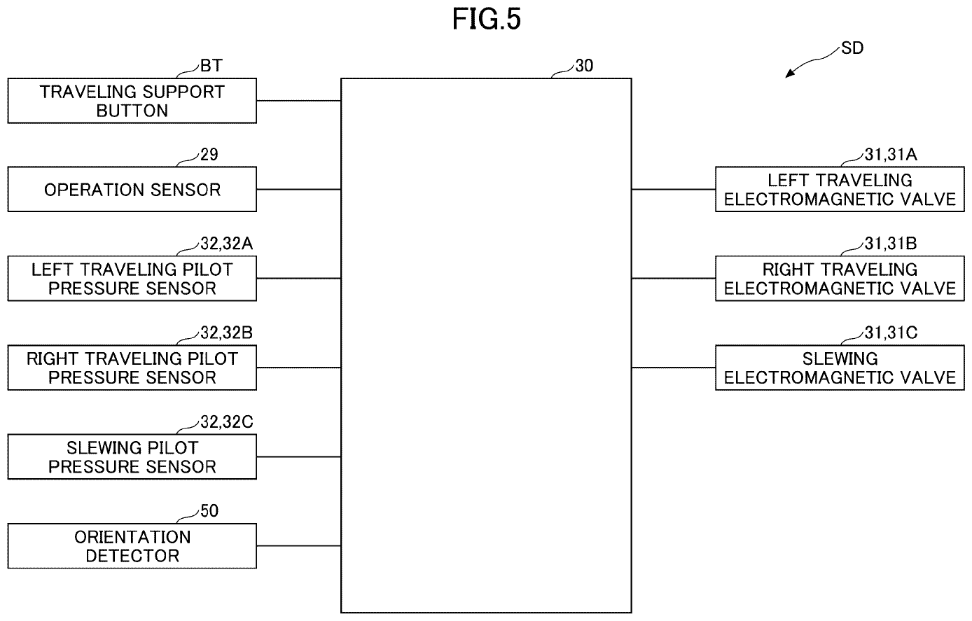

Next, a configuration example of a traveling support system SD, which is a system configured to realize the traveling support function, will be described with reference to FIG. 5. FIG. 5 is a block diagram illustrating the configuration example of the traveling support system SD.

Specifically, the traveling support system SD includes the traveling support button BT, the operation sensor 29, the orientation detector 50, the electromagnetic valve 31 (the left traveling electromagnetic valve 31A, the right traveling electromagnetic valve 31B, and the slewing electromagnetic valve 31C), the pilot pressure sensor 32 (the left traveling pilot pressure sensor 32A, the right traveling pilot pressure sensor 32B, and the slewing pilot pressure sensor 32C). The following description is applicable to a case in which the work machine 100 is remotely operated. In this case, the traveling support button BT is replaced with the traveling support button BT provided in the remote operation room RC, the operation sensor 29 is replaced with the operation sensor 43 configured to detect the operation content of the operation device 42 provided in the remote operation room RC, the controller 30 is replaced with the remote controller 40, and the operator is replaced with the remote operator OP.

The traveling support button BT is an example of an operation tool used to execute the traveling support function. The traveling support button BT is provided at the tip of at least one of the left traveling lever 26DL, the right traveling lever 26DR, the left operation lever 26L, or the right operation lever. In the illustrated example, the traveling support button BT is a momentary button provided at the tip of the left traveling lever 26DL. Here, the momentary button is a button configured to turn ON only while being pressed. For example, the operator can operate the left traveling lever 26DL by his/her left hand while pressing the traveling support button BT by his/her left thumb.

However, the traveling support button BT may be an alternate button provided at a position away from the operation device 26 in the cab 10. Here, the alternate button is a button configured to maintain an ON state after the operator releases his/her hand from the pressed button. Also, the traveling support button BT may be formed by an operation tool other than the button, such as a lever switch, a slide switch, or the like.

The controller 30 is configured to receive information output by the traveling support button BT, the operation sensor 29, and the pilot pressure sensor 32 (the left traveling pilot pressure sensor 32A, the right traveling pilot pressure sensor 32B, and the slewing pilot pressure sensor 32C), and the like, followed by executing various calculations, thereby outputting a control command to the electromagnetic valve 31 (the left traveling electromagnetic valve 31A, the right traveling electromagnetic valve 31B, and the slewing electromagnetic valve 31C), and the like.

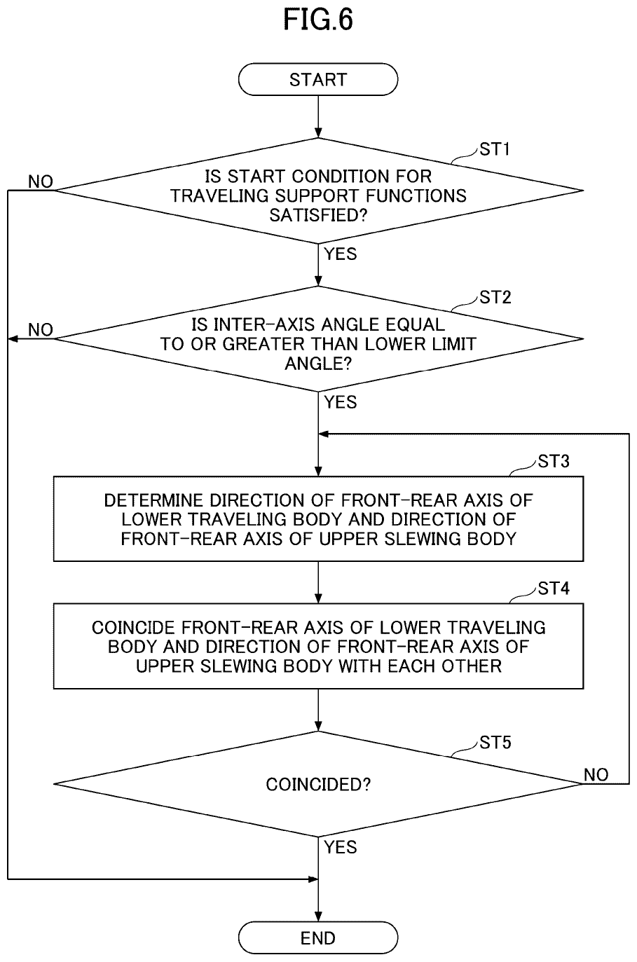

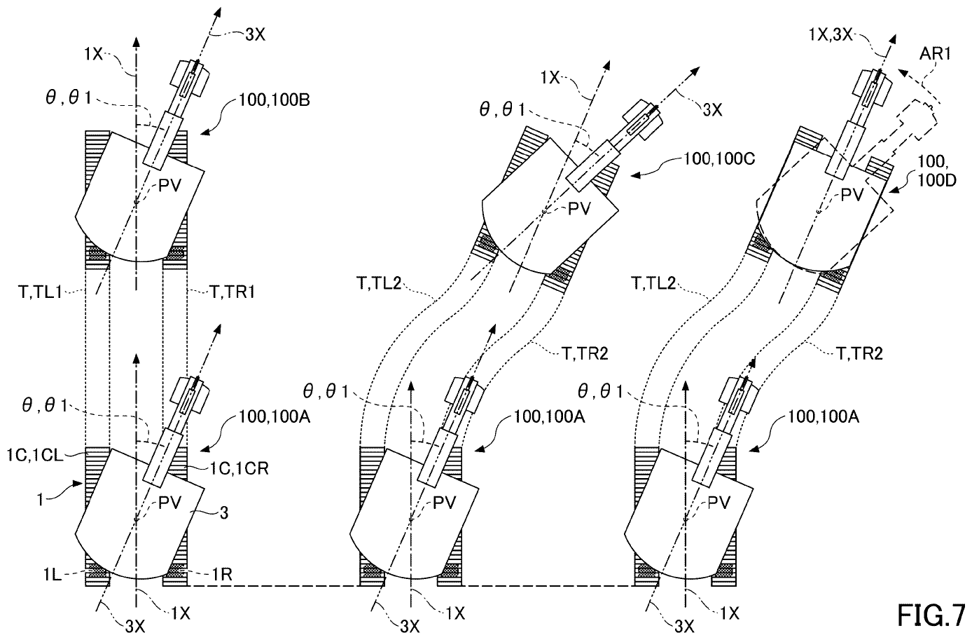

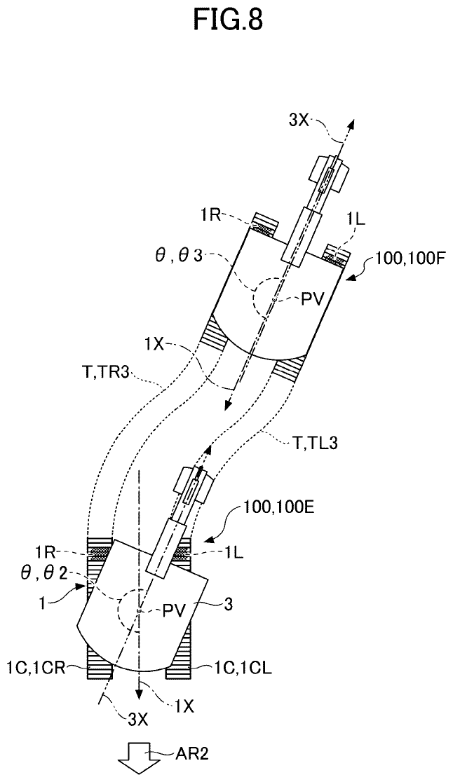

Next, a process through which the controller 30 executes the traveling support function (hereinafter this process is referred to as a “traveling support process”) will be described with reference to FIGS. 6 and 7. FIG. 6 is a flowchart illustrating an example of a flow of the traveling support process. The controller 30 is configured to repeatedly execute the traveling support process in predetermined control cycles. FIG. 7 is a top diagram of the work machine 100 illustrating an example of movement of the work machine 100 when traveling operations are performed. The forward traveling operation for the lower traveling body 1, which is one of the traveling operations, is an operation to tilt each of the left traveling lever 26DL and the right traveling lever 26DR in the forward traveling direction in the same amount of operation. Specifically, the left diagram of FIG. 7 illustrates the movement of the work machine 100 when the traveling support function is not executed, the center diagram of FIG. 7 illustrates the movement of the work machine 100 when the traveling support function including executing the automatic control of the traveling actuator DA and the automatic control of the slewing actuator SA is executed, and the right diagram of FIG. 7 illustrates the movement of the work machine 100 when the traveling support function including executing the automatic control of the traveling actuator DA and the automatic control of the slewing actuator SA is executed. In the example illustrated in FIG. 7, the work machine 100 at the start of traveling is in the state of a work machine 100A, and an inter-axis angle θ, which is an angle between a front-rear axis 1X of the lower traveling body 1 and a front-rear axis 3X of the upper slewing body 3, is an angle θ1 (>0 degrees). In FIG. 7, the front-rear axis 1X of the lower traveling body 1 and the front-rear axis 3X of the upper slewing body 3 are indicated by dashed-dotted line arrows, and the directions of the arrows indicate the directions of the front-rear axis 1X and the front-rear axis 3X (in which the arrow heads indicate front sides). Also, the inter-axis angle θ is positive in a clockwise direction relative to the front-rear axis 1X serving as a reference. Also, in FIG. 7, a work machine 100B, a work machine 100C, and a work machine 100D illustrate states of the work machine 100 after traveling a predetermined distance from the state of the work machine 100A. Also, in FIG. 7, for clearly illustrating a front-rear relationship of the lower traveling body 1 (the crawlers 1C), the positions of the left traveling hydraulic motor 1L provided at the rear end of the left crawler 1CL and the right traveling hydraulic motor 1R provided at the rear end of the right crawler 1CR are illustrated in dot patterns. The same applies to FIGS. 8 to 10, which will be referred to below.

In the traveling support process, first, the controller 30 determines whether or not a start condition for the traveling support function is satisfied (step ST1). The start condition for the traveling support function is, for example, the traveling operation device 26D being operated in a state in which the traveling support button BT is in the ON state. In the illustrated example, the start condition for the traveling support function is at least one of the left traveling lever 26DL or the right traveling lever 26DR being operated in a state in which the traveling support button BT is in the ON state. Then, the controller 30 determines whether or not the start condition for the traveling support function is satisfied based on the traveling support button BT and the output of the operation sensor 29 (the left traveling operation sensor 29DL and the right traveling operation sensor 29DR). The start condition for the traveling support function may be the traveling lever being operated at a full level or the traveling pedal being operated at a full level.

If it is determined that the start condition for the traveling support function is not satisfied (NO in step ST1), the controller 30 ends the current traveling support process.

If it is determined that the start condition for the traveling support function is satisfied (YES in step ST1), the controller 30 determines whether or not the inter-axis angle θ is equal to or greater than a predetermined lower limit angle (step ST2). In the illustrated example, the controller 30 sets, as the inter-axis angle θ, a slewing angle calculated based on the output of the slewing angle velocity sensor S5. Then, the controller 30 compares the inter-axis angle θ with the lower limit angle previously stored in a nonvolatile storage device, thereby determining whether or not the inter-axis angle θ is equal to or greater than the lower limit angle (e.g., one degree). Alternatively, the controller 30 may calculate the inter-axis angle θ based on the direction of the front-rear axis 1X and the direction of the front-rear axis 3X that are determined based on the output of the orientation detector 50.

If it is determined that the inter-axis angle θ is not equal to or greater than the lower limit angle (NO in step ST2), the controller 30 ends the current traveling support process. This is because the controller 30 can determine that it is not necessary to support the traveling of the work machine 100 since the direction of the front-rear axis 1X and the direction of the front-rear axis 3X coincide with each other.

If it is determined that the inter-axis angle θ is equal to or greater than a predetermined upper limit angle (e.g., 90 degrees), the controller 30 may end the current traveling support process. This is for suppressing the traveling support function being executed undesirably. This is because the operator of the work machine 100 may perform the traveling operation in a state of intentionally increasing the inter-axis angle θ, for example, when a slope forming operation is being performed.

If it is determined that the inter-axis angle θ is equal to or greater than the lower limit angle (YES in step ST2), the controller 30 determines the direction of the front-rear axis 1X of the lower traveling body 1 and the direction of the front-rear axis 3X of the upper slewing body 3 (step ST3). In the illustrated example, the controller 30 determines the directions of the front-rear axis 1X and the front-rear axis 3X based on the output of the orientation detector 50. When the directions of the front-rear axis 1X and the front-rear axis 3X are already determined in step ST2, the controller 30 may omit step ST3.

Subsequently, the controller 30 causes the direction of the front-rear axis 1X of the lower traveling body 1 and the direction of the front-rear axis 3X of the upper slewing body 3 to coincide with each other (step ST4). Specifically, as long as an execution condition for the traveling support function is satisfied, the controller 30 automatically drives at least one of the traveling actuator DA and the slewing actuator SA to cause the direction of the front-rear axis 1X of the lower traveling body 1 and the direction of the front-rear axis 3X of the upper slewing body 3 to coincide with each other. The execution condition for the traveling support function is typically the same as the start condition for the traveling support function.

In the example illustrated in the center diagram of FIG. 7, the controller 30 outputs a control command to the left traveling electromagnetic valve 31A and the right traveling electromagnetic valve 31B, and automatically causes the lower traveling body 1 to curve rightward along a traveling track T.

Specifically, the controller 30 causes the left crawler 1CL to move along a left traveling track TL2 independently of the operation content of the left traveling lever 26DL, and causes the right crawler 1CR to move along a right traveling track TR2 independently of the operation content of the right traveling lever 26DR, thereby coinciding, in the state of the work machine 100C, the direction of the front-rear axis 1X of the lower traveling body 1 with the direction of the front-rear axis 3X of the upper slewing body 3 at the start of traveling.

Note that the traveling track T is typically determined by the inter-axis angle θ at the start of traveling, and is not influenced by the amount of operation of the traveling operation device 26D. That is, during the execution of the traveling support function, until the direction of the front-rear axis 1X of the lower traveling body 1 and the direction of the front-rear axis 3X of the upper slewing body 3 coincide with each other, the traveling track T of the lower traveling body 1 in a larger amount of operation of the traveling operation device 26D is the same as the traveling track T of the lower traveling body 1 in a smaller amount of operation of the traveling operation device 26D. Note that the controller 30 may be configured to determine the traveling track T based on the output of the machine body tilt sensor S4, the space recognition device S6, or the like, in addition to the inter-axis angle θ at the start of traveling.

Specifically, the controller 30 may determine the traveling track T based on the inter-axis angle θ at the start of traveling and the extent of a tilt of the work machine 100, or may determine the traveling track T, for example, based on the inter-axis angle θ at the start of traveling and the presence or absence of an obstacle around the work machine 100. Typically, the traveling track T for coinciding the front-rear axis 1X and the front-rear axis 3X with each other becomes longer as the inter-axis angle θ is larger.

Also, the controller 30 may output a control command to the slewing electromagnetic valve 31C, and automatically cause the upper slewing body 3 to slew leftward as illustrated in the right diagram of FIG. 7. Specifically, the controller 30 may cause the upper slewing body 3 to slew leftward by the angle θ1 as indicated by a dashed line arrow AR1, thereby coinciding, in the state of the work machine 100D, the direction of the front-rear axis 3X of the upper slewing body 3 with the direction of the front-rear axis 1X of the lower traveling body 1. That is, the controller 30 may set the inter-axis angle θ to zero. In the illustrated example, the controller 30 causes the upper slewing body 3 to slew leftward while automatically causing the lower traveling body 1 to curve rightward along the traveling track T. Therefore, the direction of the front-rear axis 3X of the upper slewing body 3 does not change while the lower traveling body 1 is traveling. However, the controller 30 may cause the upper slewing body 3 to slew leftward after the work machine 100 is in the state of the work machine 100C (see the center diagram of FIG. 7). Alternatively, the controller 30 may automatically cause the lower traveling body 1 to curve rightward along the traveling track T after causing the upper slewing body 3 to slew leftward to coincide the direction of the front-rear axis 1X and the direction of the front-rear axis 3X with each other.

Also, in the illustrated example, the controller 30 causes the upper slewing body 3 to slew leftward while automatically causing the lower traveling body 1 to curve rightward along the traveling track T such that the direction of the front-rear axis 3X of the upper slewing body 3 does not change, i.e., such that the direction of the front-rear axis 3X of the upper slewing body 3 remains unchanged. That is, the controller 30 causes a right rotation speed (a right rotation angle per unit time) about the slewing axis PV of the front-rear axis 1X of the lower traveling body 1 and a left slewing speed (a right slewing angle per unit time) about the slewing axis PV of the front-rear axis 3X of the upper slewing body 3 to be equal to each other, i.e., to cancel each other. However, the controller 30 may cause the rotation speed about the slewing axis PV of the front-rear axis 1X of the lower traveling body 1 and the slewing speed about the slewing axis PV of the front-rear axis 3X of the upper slewing body 3 to be different from each other.

When the same forward traveling operation as described above is performed without executing the traveling support function, the work machine 100 travels straight to be in the state of the work machine 100B. Specifically, the left crawler 1CL moves along a left traveling track TL1, and the right crawler 1CR moves along a right traveling track TR1. In this case, in the state of the work machine 100B, the inter-axis angle θ remains the angle θ1, and the angle between the direction of the front-rear axis 1X of the lower traveling body 1 and the direction of the front-rear axis 3X of the upper slewing body 3 at the start of traveling also remains the angle θ1.

Subsequently, the controller 30 determines whether or not the front-rear axis 1X and the front-rear axis 3X coincide with each other (step ST5). In the illustrated example, the controller 30 determines whether or not the inter-axis angle θ becomes zero, thereby determining whether or not the front-rear axis 1X and the front-rear axis 3X coincide with each other.

If it is determined that the front-rear axis 1X and the front-rear axis 3X do not coincide with each other (NO in step ST5), the controller 30 executes the process subsequent to step ST3. That is, the controller 30 continues the automatic control of each of the traveling actuator DA and the slewing actuator SA.

If it is determined that the front-rear axis 1X and the front-rear axis 3X coincide with each other (YES in step ST5), the controller 30 ends the current traveling support function. In the illustrated example, the controller 30 stops the automatic control of each of the traveling actuator DA and the slewing actuator SA. After the stoppage of the automatic control, the work machine 100 drives the traveling actuator DA in response to a manual operation by the operator of the traveling operation device 26D, or drives the slewing actuator SA in response to a manual operation by the operator of the slewing operation device 26S. Alternatively, after the stoppage of the automatic control, the controller 30 may forcibly stop the movement of each of the traveling actuator DA and the slewing actuator SA even when the traveling operation device 26D is operated in a state in which the traveling support button BT is pressed. This is for causing the operator to make sure to recognize that the automatic control of each of the traveling actuator DA and the slewing actuator SA was stopped. Subsequently, for example, after returning each of the traveling operation device 26D and the slewing operation device 26S to be in a neutral state, i.e., a state in which no operation is performed, the operator can resume the manual operation of each of the traveling operation device 26D and the slewing operation device 26S.

As described above, by executing the traveling support function, e.g., tilting at least one of the left traveling lever 26DL or the right traveling lever 26DR in the forward traveling direction while pressing the traveling support button BT, the controller 30 can cause the direction of the front-rear axis 1X to coincide with the direction of the front-rear axis 3X at the start of traveling, and further, can cause the direction of the front-rear axis 3X to coincide with the direction of the front-rear axis 1X.

Next, another example of the traveling support function will be described with reference to FIG. 8. FIG. 8 is a top diagram of the work machine 100 illustrating another example of the movement of the work machine 100 when the traveling operations are performed. FIG. 8 corresponds to the right diagram of FIG. 7. Specifically, FIG. 8 illustrates the movement of the work machine 100 when the traveling support function including executing the automatic control of the traveling actuator DA and the automatic control of the slewing actuator SA is executed. In the example illustrated in FIG. 8, the work machine 100 is in the state of a work machine 100E at the start of traveling, and the inter-axis angle θ is an angle θ2 (>180 degrees). Also, a work machine 100F illustrated in FIG. 8 is the work machine 100 after the work machine 100E traveled a predetermined distance, i.e., after the lower traveling body 1 traveled rearward.

The example illustrated in FIG. 8 is different from the example illustrated in FIG. 7 in that the direction of the front-rear axis 1X of the lower traveling body 1 and the direction of the front-rear axis 3X of the upper slewing body 3 are substantially opposite to each other at the start of traveling, i.e., in the work machine 100E. In the example illustrated in FIG. 7, the inter-axis angle θ is less than 45 degrees.

Therefore, in the state of the work machine 100E, when the forward traveling operation is performed without executing the traveling support function, the work machine 100 moves in a direction indicated by a block arrow AR2, i.e., rearward as viewed from the upper slewing body 3.

When the traveling support function is executed, the controller 30 can cause the work machine 100 to travel along the traveling track T in a forward direction as viewed from the upper slewing body 3. Specifically, the controller 30 may be configured, as long as the inter-axis angle θ is equal to or greater than a predetermined angle (e.g., 135 degrees), to cause the lower traveling body 1 to travel rearward when the traveling operation device 26D is operated in the forward traveling direction. In this case, for example, when the left traveling lever 26DL and the right traveling lever 26DR are tilted in the forward traveling direction in the same amount of operation in a state in which the traveling support button BT is pressed, the left crawler 1CL moves (travels rearward) along a left traveling track TL3, and the right crawler 1CR moves (travels rearward) along a right traveling track TR3, as illustrated in FIG. 8. As a result, the upper slewing body 3 moves (travels forward) to the state of the work machine 100F. In the state of the work machine 100F, the direction of the front-rear axis 1X of the lower traveling body 1 and the direction of the front-rear axis 3X of the upper slewing body 3 at the start of traveling coincide with each other, and also, the direction of the front-rear axis 1X of the lower traveling body 1 and the direction of the front-rear axis 3X of the upper slewing body 3 coincide with each other. Here, the direction of the front-rear axis 1X of the lower traveling body 1 is exactly opposite to the direction of the front-rear axis 3X of the upper slewing body 3. That is, the inter-angle θ is an angle θ3 (180 degrees).

If it is determined that the front-rear axis 1X and the front-rear axis 3X coincide with each other, the controller 30 may stop the automatic control of each of the traveling actuator DA and the slewing actuator SA, and then resume the movement of the actuators in response to a manual operation. In this case, the controller 30 may be configured, at the time of stoppage of the automatic control, to stop each of the traveling actuator DA and the slewing actuator SA, and notify the operator that the direction of the front-rear axis 1X of the lower traveling body 1 is exactly opposite to the direction of the front-rear axis 3X of the upper slewing body 3. This notification may be performed using a display device or a speaker. This is for suppressing the lower traveling body 1 traveling rearward against the intention of the operator when the manual operation is resumed. Note that this notification may be performed when the traveling support function is started.

Alternatively, after it is determined that the front-rear axis 1X and the front-rear axis 3X coincide with each other, as long as the traveling support button BT is pressed, i.e., the traveling support function is executed, the controller 30 may execute a forward/rearward traveling reverse mode. The forward/rearward traveling reverse mode is an operation mode of the lower traveling body 1 in which: when the left traveling lever 26DL is operated in the forward traveling direction, the right crawler 1CR travels rearward in accordance with the amount of the operation; when the left traveling lever 26DL is operated in the rearward traveling direction, the right crawler 1CR travels forward in accordance with the amount of the operation; when the right traveling lever 26DR is operated in the forward traveling direction, the left crawler 1CL travels rearward in accordance with the amount of the operation; and when the right traveling lever 26DR is operated in the rearward traveling direction, the left crawler 1CL travels forward in accordance with the amount of the operation. In this case, when the front-rear axis 1X and the front-rear axis 3X coincide with each other, the controller 30 can continue the movement of the lower traveling body 1 without stopping the movement of the lower traveling body 1. Thus, the controller 30 can realize a smooth movement of the lower traveling body 1.

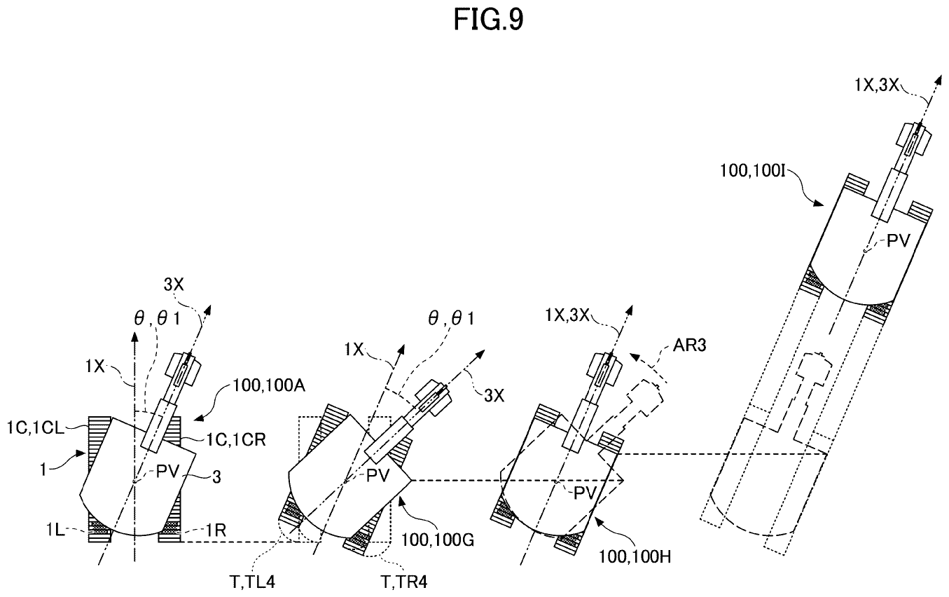

Next, yet another example of the traveling support function will be described with reference to FIG. 9. FIG. 9 is a top diagram of the work machine 100 illustrating yet another example of the movement of the work machine 100 when the traveling operations are performed. FIG. 9 corresponds to the right diagram of FIG. 7 and FIG. 8. Specifically, FIG. 9 illustrates the movement of the work machine 100 when the traveling support function including executing the automatic control of the traveling actuator DA and the automatic control of the slewing actuator SA is executed. Also, in the example illustrated in FIG. 9, at the start of traveling, the work machine 100 is in the state of the work machine 100A, and the inter-axis angle θ is the angle θ1 (>0 degrees). Also, in FIG. 9, a work machine 100G illustrates the state of the work machine 100 after performing spin turning from the state of the work machine 100A, a work machine 100H illustrates the state of the work machine 100 after performing leftward slewing from the state of the work machine 100G, and a work machine 100I illustrates the state of the work machine 100 after traveling a predetermined distance from the state of the work machine 100H.

The example illustrated in FIG. 9 is different from the examples illustrated in FIGS. 7 and 8 in that the spin turning is used when causing the direction of the front-rear axis 1X of the lower traveling body 1 to coincide with the direction of the front-rear axis 3X of the upper slewing body 3 at the start of traveling.

Specifically, by moving the left crawler 1CL along a left traveling track TL4 and the right crawler 1CR along a right traveling track TR4, the controller 30 can cause, in the state of the work machine 100G, the direction of the front-rear axis 1X of the lower traveling body 1 to coincide with the direction of the front-rear axis 3X of the upper slewing body 3 at the start of traveling, which is illustrated in the leftmost diagram of FIG. 9.

Subsequently, by slewing the upper slewing body 3 leftward by the angle θ1 as indicated by a dashed line arrow AR3, the controller 30 can cause, in the state of the work machine 100H, to coincide the direction of the front-rear axis 3X of the upper slewing body 3 with the direction of the front-rear axis 1X of the lower traveling body 1.

Subsequently, if it is determined that the front-rear axis 1X and the front-rear axis 3X coincide with each other, the controller 30 may stop the movement of each of the traveling actuator DA and the slewing actuator SA even if the traveling operation device 26D is operated in a state in which the traveling support button BT is pressed. This is for causing the operator to make sure to recognize that the automatic control of each of the traveling actuator DA and the slewing actuator SA was stopped. Subsequently, for example, after returning each of the traveling operation device 26D and the slewing operation device 26S to be in a neutral state, the operator can resume a manual operation of each of the traveling operation device 26D and the slewing operation device 26S.

The manual operation of each of the left traveling lever 26DL and the right traveling lever 26DR performed in the forward traveling direction in the same amount of operation results in the work machine 100I, i.e., the work machine 100 after traveling a predetermined distance from the state of the work machine 100H.

In the example illustrated in FIG. 9, the controller 30 performs the spin turning by the automatic control of the traveling actuator DA, and then performs the leftward slewing by the automatic control of the slewing actuator SA. However, the spin turning and the leftward slewing may be performed at the same time, or the spin turning may be performed after the leftward slewing.

Also, in the example illustrated in FIG. 9, the controller 30 performs the spin turning and the leftward slewing by the automatic control when each of the left traveling lever 26DL and the right traveling lever 26DR is operated in the forward traveling direction in the same amount of operation in a state in which the traveling support button BT is pressed. However, the controller 30 may perform the spin turning and the leftward slewing by the automatic control when the left traveling lever 26DL is operated in the forward traveling direction and the right traveling lever 26DR is operated in the rearward traveling direction in a state in which the traveling support button BT is pressed.

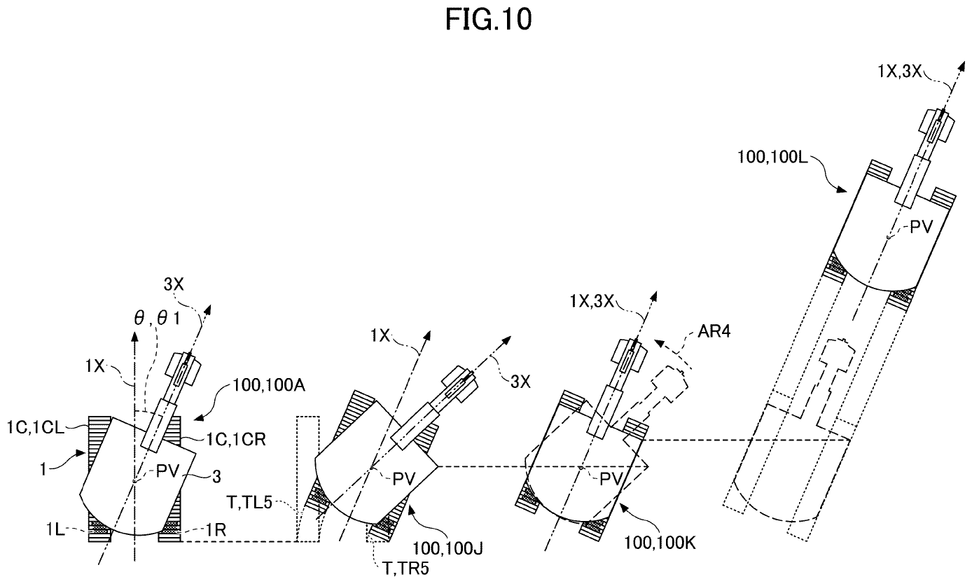

Next, yet another example of the traveling support function will be described with reference to FIG. 10. FIG. 10 is a top diagram of the work machine 100 illustrating yet another example of the movement of the work machine 100 when the traveling operations are performed. FIG. 10 corresponds to the right diagram of FIG. 7, FIG. 8, and FIG. 9. Specifically, FIG. 10 illustrates the movement of the work machine 100 when the traveling support function including executing the automatic control of the traveling actuator DA and the automatic control of the slewing actuator SA is executed. In the example illustrated in FIG. 10, at the start of traveling, the work machine 100 is in the state of the work machine 100A, and the inter-axis angle θ is the angle θ1 (>0 degrees). Also, in FIG. 10, a work machine 100J illustrates the state of the work machine 100 after performing pivot turning from the state of the work machine 100A, a work machine 100K illustrates the state of the work machine 100 after performing leftward slewing from the state of the work machine 100J, and a work machine 100L illustrates the state of the work machine 100 after traveling a predetermined distance from the state of the work machine 100K.

The example illustrated in FIG. 10 is different from the examples illustrated in FIGS. 7 and 8 and the example illustrated in FIG. 9 using the spin turning, in that the pivot turning is used when causing the direction of the front-rear axis 1X of the lower traveling body 1 to coincide with the direction of the front-rear axis 3X of the upper slewing body 3 at the start of traveling.

Specifically, by moving the left crawler 1CL along a left traveling track TL5 and the right crawler 1CR along a right traveling track TR5, the controller 30 can cause, in the state of the work machine 100J, the direction of the front-rear axis 1X of the lower traveling body 1 to coincide with the direction of the front-rear axis 3X of the upper slewing body 3 at the start of traveling, which is illustrated in the leftmost diagram of FIG. 10. In this example, the movement of the right crawler 1CR is a passive movement caused by the movement of the left crawler 1CL.

Subsequently, by slewing the upper slewing body 3 leftward by the angle θ1 as indicated by a dashed line arrow AR4, the controller 30 can cause, in the state of the work machine 100K, to coincide the direction of the front-rear axis 3X of the upper slewing body 3 with the direction of the front-rear axis 1X of the lower traveling body 1.

Subsequently, if it is determined that the front-rear axis 1X and the front-rear axis 3X coincide with each other, the controller 30 may stop the movement of each of the traveling actuator DA and the slewing actuator SA even if the traveling operation device 26D is operated in a state in which the traveling support button BT is pressed. This is for causing the operator to make sure to recognize that the automatic control of each of the traveling actuator DA and the slewing actuator SA was stopped. Subsequently, for example, after returning each of the traveling operation device 26D and the slewing operation device 26S to be in a neutral state, the operator can resume a manual operation of each of the traveling operation device 26D and the slewing operation device 26S.

The manual operation of each of the left traveling lever 26DL and the right traveling lever 26DR performed in the forward traveling direction in the same amount of operation results in the work machine 100L, i.e., the work machine 100 after traveling a predetermined distance from the state of the work machine 100K.

In the example illustrated in FIG. 10, the controller 30 performs the pivot turning by the automatic control of the traveling actuator DA, and then performs the leftward slewing by the automatic control of the slewing actuator SA. However, the pivot turning and the leftward slewing may be performed at the same time, or the pivot turning may be performed after the leftward slewing.

Also, in the example illustrated in FIG. 10, the controller 30 performs the pivot turning and the leftward slewing by the automatic control when each of the left traveling lever 26DL and the right traveling lever 26DR is operated in the forward traveling direction in the same amount of operation in a state in which the traveling support button BT is pressed. However, the controller 30 may perform the pivot turning and the leftward slewing by the automatic control when only the left traveling lever 26DL is operated in the forward traveling direction in a state in which the traveling support button BT is pressed.

As described above, the work machine 100 according to the embodiment of the present disclosure includes, as illustrated in FIG. 2, the lower traveling body 1, the upper slewing body 3 slewably mounted on the lower traveling body 1, the slewing actuator SA configured to slew the upper slewing body 3 about the slewing axis PV relative to the lower traveling body 1, and the traveling actuator DA configured to cause the lower traveling body 1 to travel. As illustrated in the center diagram of FIG. 7, the work machine 100 is configured to execute the traveling support function that executes the automatic control of the traveling actuator DA and causes the direction of the front-rear axis 1X of the lower traveling body 1 and the direction of the front-rear axis 3X of the upper slewing body 3 to coincide with each other during the traveling of the lower traveling body 1.

This configuration provides the effect that the operator of the work machine 100 can cause the direction of the front-rear axis 1X of the lower traveling body 1 and the direction of the front-rear axis 3X of the upper slewing body 3 to coincide with each other by a simple operation. Also, with this configuration, the operator can move the lower traveling body 1 in a direction in which the upper slewing body 3 faces, without performing a complicated traveling operation, such as, for example, causing the amount of operation of the left traveling lever 26DL and the amount of operation of the right traveling lever 26DR to differ from each other. Therefore, this configuration provides the effect of enabling improving the efficiency of traveling of the work machine 100.

Note that causing the direction of the front-rear axis 1X of the lower traveling body 1 and the direction of the front-rear axis 3X of the upper slewing body 3 to coincide with each other may be causing the direction of the front-rear axis 1X of the lower traveling body 1 at the current point in time and the direction of the front-rear axis 3X of the upper slewing body 3 at the start of traveling to coincide with each other, or may be causing the direction of the front-rear axis 1X of the lower traveling body 1 at the current point in time and the direction of the front-rear axis 3X of the upper slewing body 3 at the current point in time to coincide with each other.

The former configuration provides the effect that the operator of the work machine 100 can cause the lower traveling body 1 to travel along the direction of the front-rear axis 3X of the upper slewing body 3 at the start of traveling by a simple operation. The latter configuration provides the effect that the operator of the work machine 100 can cause the lower traveling body 1 to travel by a simple operation in a state in which the direction of the front-rear axis 1X of the lower traveling body 1 and the direction of the front-rear axis 3X of the upper slewing body 3 coincide with each other.

Also, the work machine 100 may be configured to execute the traveling support function by executing the automatic control of the traveling actuator DA to automatically change the direction of the front-rear axis 1X of the lower traveling body 1. For example, the work machine 100 may be configured to execute the traveling support function by automatically causing the rotation speed of the left traveling hydraulic motor 1L and the rotation speed of the right traveling hydraulic motor 1R to differ from each other to automatically change the direction of the front-rear axis 1X of the lower traveling body 1.

With this configuration, the operator of the work machine 100 can automatically cause the lower traveling body 1 to curve, for example, as illustrated in the center diagram of FIG. 7, only by performing an operation to cause the lower traveling body 1 to travel straight in the forward direction. Therefore, the operator can cause the lower traveling body 1 to travel along the direction of the front-rear axis 3X of the upper slewing body 3 at the start of traveling without performing a complicated operation, such as causing the amount of operation of the left traveling lever 26DL and the amount of operation of the right traveling lever 26DR to differ from each other.

The slewing actuator SA may be configured to be automatically driven without operating the slewing operation device 26S.

With this configuration, the operator of the work machine 100 can automatically cause the lower traveling body 1 to curve and automatically cause the upper slewing body 3 to slew, for example, as illustrated in the right diagram of FIG. 7, only by performing an operation to cause the lower traveling body 1 to travel straight in the forward direction. Thus, without performing a complicated operation, such as operating the slewing operation lever while operating the traveling lever, the operator can cause the front-rear axis 1X and the front-rear axis 3X to coincide with each other, and cause the lower traveling body 1 to travel along the direction of the front-rear axis 3X of the upper slewing body 3 at the start of traveling. Also, with this configuration, without performing the slewing operation of the upper slewing body 3 and the complicated traveling operation, the operator can move the lower traveling body 1 in the direction in which the upper slewing body 3 faces in a state in which the front-rear axis 1X and the front-rear axis 3X coincide with each other. Therefore, this configuration provides the effect of enabling further improving the efficiency of traveling of the work machine 100.

Also, the automatic control of the traveling actuator DA may be stopped when the direction of the front-rear axis 1X of the lower traveling body 1 and the direction of the front-rear axis 3X of the upper slewing body 3 at the start of traveling coincide with each other. That is, the controller 30 may be configured to switch the automatic control of the traveling actuator DA to manual control when the direction of the front-rear axis 1X of the lower traveling body 1 and the direction of the front-rear axis 3X of the upper slewing body 3 at the start of traveling coincide with each other.

With this configuration, after the direction of the front-rear axis 1X of the lower traveling body 1 and the direction of the front-rear axis 3X of the upper slewing body 3 at the start of traveling coincide with each other, the operator of the work machine 100 can cause the lower traveling body 1 to face in a desired direction by manually operating the traveling operation device 26D.

During the execution of the traveling support function, until the direction of the front-rear axis 1X of the lower traveling body 1 and the direction of the front-rear axis 3X of the upper slewing body 3 coincide with each other, the traveling actuator DA may be automatically controlled such that the traveling track T of the lower traveling body 1 in a larger amount of operation of the traveling operation device 26D becomes the same as the traveling track T of the lower traveling body 1 in a smaller amount of operation of the traveling operation device 26D. Also, the work machine 100 is basically configured such that the traveling speed of the lower traveling body 1 increases as the amount of operation of the traveling operation device 26D is larger. However, the work machine 100 may be configured, during the execution of the traveling support function, such that the traveling speed of the lower traveling body 1 does not change, i.e., the traveling speed of the lower traveling body 1 is maintained at a predetermined traveling speed, even if the amount of operation of the traveling operation device 26D changes.

With this configuration, the work machine 100 can suppress the traveling track T changing in accordance with the amount of operation of the traveling operation device 26D. Therefore, the operator of the work machine 100 can use the traveling support function without excessively paying attention to the amount of operation of the traveling operation device 26D.

Also, the work machine 100 may be configured to execute the traveling support function when an operation for the spin or pivot turning is performed, and stop the lower traveling body 1 when the direction of the front-rear axis 1X of the lower traveling body 1 and the direction of the front-rear axis 3X of the upper slewing body 3 coincide with each other.

With this configuration, for example, simply by tilting the left traveling lever 26DL in the forward traveling direction and tilting the right traveling lever 26DR in the rearward traveling direction while pressing the traveling support button BT, the operator of the work machine 100 can execute the spin turning to enable the direction of the front-rear axis 1X of the lower traveling body 1 and the direction of the front-rear axis 3X of the upper slewing body 3 at the start of traveling (at the start of the spin turning) to coincide with each other, as illustrated in FIG. 9. In this case, the lower traveling body 1 stops at the time the direction of the front-rear axis 1X of the lower traveling body 1 and the direction of the front-rear axis 3X of the upper slewing body 3 at the start of traveling (at the start of the spin turning) coincide with each other. Therefore, after the stoppage of the lower traveling body 1, the operator enables the lower traveling body 1 to travel along the direction of the front-rear axis 3X of the upper slewing body 3 at the start of traveling (at the start of the spin turning) by manually operating again the left traveling lever 26DL and the right traveling lever 26DR returned to the neutral state. The same applies to the case of executing the pivot turning.

Also, the work machine 100 may be configured to execute the traveling support function when the inter-axis angle θ, which is the angle between the front-rear axis 1X of the lower traveling body 1 and the front-rear axis 3X of the upper slewing body 3, is less than a predetermined upper limit angle.

This configuration provides the effect of enabling suppressing the inter-axis angle θ changing due to the traveling support function being executed undesirably in a state in which the operator of the work machine 100 intentionally increases the inter-axis angle θ.

Also, when the inter-axis angle θ, which is the angle between the front-rear axis 1X of the lower traveling body 1 and the front-rear axis 3X of the upper slewing body 3, is equal to or greater than a predetermined angle, the work machine 100 may be configured to cause the lower traveling body 1 to travel forward when the traveling operation device 26D is operated in the rearward traveling direction.

With this configuration, the operator of the work machine 100 can use the traveling support function even if the direction of the front-rear axis 1X of the lower traveling body 1 and the direction of the front-rear axis 3X of the upper slewing body 3 are opposite to each other, for example, as illustrated in FIG. 8.

Also, when the inter-axis angle θ is equal to or greater than a predetermined angle, until the direction of the front-rear axis 1X of the lower traveling body 1 and the direction of the front-rear axis 3X of the upper slewing body 3 coincide with each other, the work machine 100 may be configured to cause the lower traveling body 1 to travel forward when the traveling operation device 26D is operated in the rearward traveling direction. In other words, after the direction of the front-rear axis 1X of the lower traveling body 1 and the direction of the front-rear axis 3X of the upper slewing body 3 coincide with each other, the work machine 100 may be configured to cause the lower traveling body 1 to travel rearward when the traveling operation device 26D is operated in the rearward traveling direction. This is for suppressing the forward/rearward traveling reverse mode continuing indefinitely, which is a special operation mode in which the lower traveling body 1 is caused to travel forward when the traveling operation device 26D is operated in the rearward traveling direction. Also, even if the inter-axis angle θ is equal to or greater than a predetermined angle, a traveling operation is considered to be more readily performed in a state in which the direction of the front-rear axis 1X of the lower traveling body 1 and the direction of the front-rear axis 3X of the upper slewing body 3 coincide with each other than in a state in which the direction of the front-rear axis 1X of the lower traveling body 1 and the direction of the front-rear axis 3X of the upper slewing body 3 do not coincide with each other. Note that the work machine 100 may be configured to stop each of the traveling actuator DA and the slewing actuator SA when the direction of the front-rear axis 1X of the lower traveling body 1 and the direction of the front-rear axis 3X of the upper slewing body 3 coincide with each other, and to notify the operator that the direction of the front-rear axis 1X of the lower traveling body 1 and the direction of the front-rear axis 3X of the upper slewing body 3 are exactly opposite to each other. This notification may be performed using a display device or a speaker. This is for suppressing the lower traveling body 1 traveling rearward against the intention of the operator when the manual operation is resumed.

With this configuration, the work machine 100 can suppress the traveling operation continuing for a long period of time in a state in which the operator does not notice that the forward/rearward traveling reverse mode is being executed or in a state in which the operator is not aware that the forward/rearward traveling reverse mode is being executed.

Also, when the inter-axis angle θ is equal to or greater than a predetermined angle, the work machine 100 may be configured, during the execution of the traveling support function, to cause the lower traveling body 1 to travel forward when the traveling operation device 26D is operated in the rearward traveling direction. In other words, at the end of the execution of the traveling support function, the work machine 100 may be configured to cause the lower traveling body 1 to travel rearward when the traveling operation device 26D is operated in the rearward traveling direction. This is for suppressing the forward/rearward traveling reverse mode continuing indefinitely.

With this configuration, as long as the traveling support function is being executed, the work machine 100 can continue the forward/rearward traveling reverse mode even after the direction of the front-rear axis 1X of the lower traveling body 1 and the direction of the front-rear axis 3X of the upper slewing body 3 coincide with each other. Furthermore, the work machine 100 can suppress the traveling operation continuing for a long period of time in a state in which the operator does not notice that the forward/rearward traveling reverse mode is being executed or in a state in which the operator is not aware that the forward/rearward traveling reverse mode is being executed.

Also, the remote operation system SYS for the work machine according to the embodiment of the present disclosure desirably includes the work machine 100 as described above and a control device configured to execute the traveling support function. The control device configured to execute the traveling support function may be, for example, the controller 30 mounted in the cab 10 of the work machine 100 or the remote controller 40 installed in the remote operation room RC.

This configuration provides the effect that, even if the control device configured to execute the traveling support function is installed in the remote operation room RC, the operator of the work machine 100 enables the lower traveling body 1, by a simple operation, to travel along the direction of the front-rear axis 3X of the upper slewing body 3 at the start of traveling, as in the case in which the control device configured to execute the traveling support function is mounted in the work machine 100. The work machine 100 may be configured such that the controller 30 mounted in the cab 10 executes the traveling support function even when a remote operation is performed.

The embodiments of the present disclosure have been described above. However, the invention according to the present disclosure is not limited to the above-described embodiments. Various modifications, substitutions, and the like may be applicable to the above-described embodiments without departing from the scope of the invention according to the present disclosure. Also, the features described with reference to the above-described embodiments may be appropriately combined as long as there is no technical contradiction.

For example, in the above-described embodiments, the traveling support function is executed when each of the left traveling lever 26DL and the right traveling lever 26DR is tilted in the forward traveling direction in a state in which the traveling support button BT is pressed. However, the traveling support function may be executed, for example, when the left operation lever 26L is tilted forward in a state in which the traveling support button BT is pressed. This operation mode is referred to as a one-lever operation mode. The operation device 26 used in the one-lever operation mode may be the right operation lever. By using the one-lever operation mode, the operator of the work machine 100 can use the traveling support function only by operating the single operation lever.

Also, in the above-described embodiments, the controller 30 is configured to execute the traveling support function that executes automatic control of each of the traveling actuator DA and the slewing actuator SA and causes the direction of the front-rear axis 1X of the lower traveling body 1 and the direction of the front-rear axis 3X of the upper slewing body 3 to coincide with each other during the traveling of the lower traveling body 1. However, the controller 30 may be configured to execute the traveling support function that executes automatic control of each of the traveling actuator DA, the slewing actuator SA, and the working actuator WA to automatically change a posture of the attachment AT to a predetermined traveling posture and causes the direction of the front-rear axis 1X of the lower traveling body 1 and the direction of the front-rear axis 3X of the upper slewing body 3 to coincide with each other during traveling of the lower traveling body 1. The traveling posture of the attachment AT is, for example, a posture when the arm 5 and the bucket 6 are completely closed and the boom 4 is raised to a predetermined position.

What is claimed is:

1. A work machine, comprising:
a lower traveling body;
an upper slewing body slewably mounted on the lower traveling body;
a slewing actuator configured to slew the upper slewing body relative to the lower traveling body;
a traveling actuator configured to cause the lower traveling body to travel; and
a controller including a memory and a processor coupled to the memory, wherein
the controller is configured to execute a traveling support function that executes automatic control of the traveling actuator and causes a direction of a front-rear axis of the lower traveling body and a direction of a front-rear axis of the upper slewing body to coincide with each other during traveling of the lower traveling body.

2. The work machine according to claim 1, wherein
causing the direction of the front-rear axis of the lower traveling body and the direction of the front-rear axis of the upper slewing body to coincide with each other includes:
causing the direction of the front-rear axis of the lower traveling body at a current point in time and the direction of the front-rear axis of the upper slewing body at a start of traveling to coincide with each other; or
causing the direction of the front-rear axis of the lower traveling body at the current point in time and the direction of the front-rear axis of the upper slewing body at the current point in time to coincide with each other.

3. The work machine according to claim 1, wherein
the controller is configured to execute the traveling support function by executing the automatic control of the traveling actuator to automatically change the direction of the front-rear axis of the lower traveling body.

4. The work machine according to claim 1, wherein
the slewing actuator is configured to be automatically driven without an operation performed to a slewing operation device.

5. The work machine according to claim 1, wherein
the automatic control of the traveling actuator is stopped in a case in which the direction of the front-rear axis of the lower traveling body and the direction of the front-rear axis of the upper slewing body at a start of traveling coincide with each other.

6. The work machine according to claim 1, wherein
during the execution of the traveling support function, until the direction of the front-rear axis of the lower traveling body and the direction of the front-rear axis of the upper slewing body coincide with each other, a traveling track of the lower traveling body in a larger amount of operation of a traveling operation device is same as a traveling track of the lower traveling body in a smaller amount of operation of the traveling operation device.

7. The work machine according to claim 4, wherein
the controller is configured to
execute the traveling support function in a case in which an operation for spin turning or pivot turning is executed, and
stop the lower traveling body in a case in which the direction of the front-rear axis of the lower traveling body and the direction of the front-rear axis of the upper slewing body coincide with each other.

8. The work machine according to claim 1, wherein
the work machine is configured to execute the traveling support function in a case in which an inter-axis angle is less than a predetermined upper limit angle, and
the inter-axis angle is an angle between the front-rear axis of the lower traveling body and the front-rear axis of the upper slewing body.

9. The work machine according to claim 1, wherein
the controller is configured to cause the lower traveling body to travel forward in response to a traveling operation device being operated in a rearward traveling direction in a case in which an inter-axis angle is equal to or greater than a predetermined angle, and
the inter-axis angle is an angle between the front-rear axis of the lower traveling body and the front-rear axis of the upper slewing body.

10. The work machine according to claim 9, wherein
in the case in which the inter-axis angle is equal to or greater than the predetermined angle, until the direction of the front-rear axis of the lower traveling body and the direction of the front-rear axis of the upper slewing body coincide with each other, the controller is configured to cause the lower traveling body to travel forward in response to the traveling operation device being operated in the rearward traveling direction.

11. The work machine according to claim 9, wherein
in the case in which the inter-axis angle is equal to or greater than the predetermined angle, during the execution of the traveling support function, the controller is configured to cause the lower traveling body to travel forward in response to the traveling operation device being operated in the rearward traveling direction.

12. A remote operation system for a work machine, the remote operation system comprising:
the work machine of claim 1; and
a control device including a memory and a processor coupled to the memory, the control device being configured to execute the traveling support function.
